(19) United States
(12) Patent Application Publication
(10) Pub. No.: US 2012/0133202 A1
(43) Pub. Date: May 31, 2012

(54) DYNAMIC REGENERATIVE BRAKING TORQUE CONTROL

(75) Inventors: DANNY Y. MUI, BIRMINGHAM, MI (US); ERIC E. KRUEGER, CHELSEA, MI (US); KEVIN S. KIDSTON, NEW HUDSON, MI (US)

(73) Assignee: GM GLOBAL TECHNOLOGY OPERATIONS, INC., DETROIT, MI (US)

(21) Appl. No.: 12/954,967

(22) Filed: Nov. 29, 2010

(51) Int. Cl. B60T 8/60; G06F 19/00; B60L 7/26

(52) U.S. Cl. 303/152; 701/71

(57) ABSTRACT

Methods, systems, and program products for adjusting regenerative braking torque in a vehicle having wheels and a regenerative braking system providing the regenerative braking torque are provided. A deceleration of the vehicle is determined. A wheel slip of the wheels is determined. The regenerative braking torque is adjusted for the regenerative braking system using the deceleration and the wheel slip.

### TECHNICAL FIELD

The present disclosure generally relates to the field of vehicles and, more specifically, to methods and systems for controlling regenerating braking torque in vehicles.

### BACKGROUND

Automobiles and various other vehicles include braking systems for reducing vehicle speed or bringing the vehicle to a stop. Such braking systems generally include a controller that provides braking pressure to braking calipers on one or both axles of the vehicle to produce braking torque for the vehicle. For example, in a regenerative braking system, hydraulic or other braking pressure is generally provided for both a non-regenerative braking axle and a regenerative braking axle. Regenerative braking systems may disable regenerative braking when a determination is made that the vehicle may become unstable. However, existing regenerative braking systems may disable regenerative braking in dynamic situations in which use of some regenerative braking would still be ideal.

Accordingly, it is desirable to provide an improved method for controlling braking for a vehicle that allows for improved control of regenerative braking torque, for example that may provide for greater use of regenerative braking in dynamic situations. It is also desirable to provide an improved system and program product for such improved control of regenerative braking torque. Furthermore, other desirable features and characteristics of the present invention will be apparent from the subsequent detailed description and the appended claims, taken in conjunction with the accompanying drawings and the foregoing technical field and background.

### SUMMARY

In accordance with an exemplary embodiment, a method for adjusting regenerative braking torque in a vehicle having wheels and a regenerative braking system providing the regenerative braking torque is provided. The method comprises the steps of determining a deceleration of the vehicle, determining a wheel slip of the wheels, and adjusting the regenerative braking torque for the regenerative braking system, via a processor, using the deceleration and the wheel slip.

In accordance with another exemplary embodiment, a program product for adjusting regenerative braking torque in a vehicle having wheels and a regenerative braking system providing the regenerative braking torque is provided. The program product comprises a program and a non-transitory computer readable medium. The program is configured to determine a deceleration of the vehicle, determine a wheel slip of the wheels, and adjust the regenerative braking torque for the regenerative braking system using the deceleration and the wheel slip. The non-transitory computer readable medium bears the program and contains computer instructions stored therein for causing a computer processor to execute the program.

In accordance with a further exemplary embodiment, a system for adjusting regenerative braking torque in a vehicle having wheels and a regenerative braking system providing the regenerative braking torque is provided. The system comprises one or more sensors and a processor. The one or more sensors are configured to measure a wheel speed of the wheels. The processor is coupled to the one or more sensors, and is configured to determine a deceleration of the vehicle, determine a wheel slip using the wheel speed, and adjust the regenerative braking torque for the regenerative braking system using the deceleration and the wheel slip.

### BRIEF DESCRIPTION OF THE DRAWINGS

The present disclosure will hereinafter be described in conjunction with the following drawing figures, wherein like numerals denote like elements, and wherein:

FIG. 1 is a functional block diagram of a braking system for a vehicle, such as an automobile, that adjusts regenerative braking torque, in accordance with an exemplary embodiment;

FIG. 2 is a flowchart of a process for controlling braking and for adjusting regenerative braking torque in a vehicle, such as an automobile, and that can be utilized in connection with the braking system of FIG. 1, in accordance with an exemplary embodiment;

FIG. 3 is a graphical representation illustrating additional regenerative braking that may be attained using the braking system of FIG. 1 and the process of FIG. 2, in accordance with an exemplary embodiment; and

FIG. 4 is a graphical representation illustrating relative amounts of regenerative braking that may be provided using the braking system of FIG. 1 and the process of FIG. 1, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

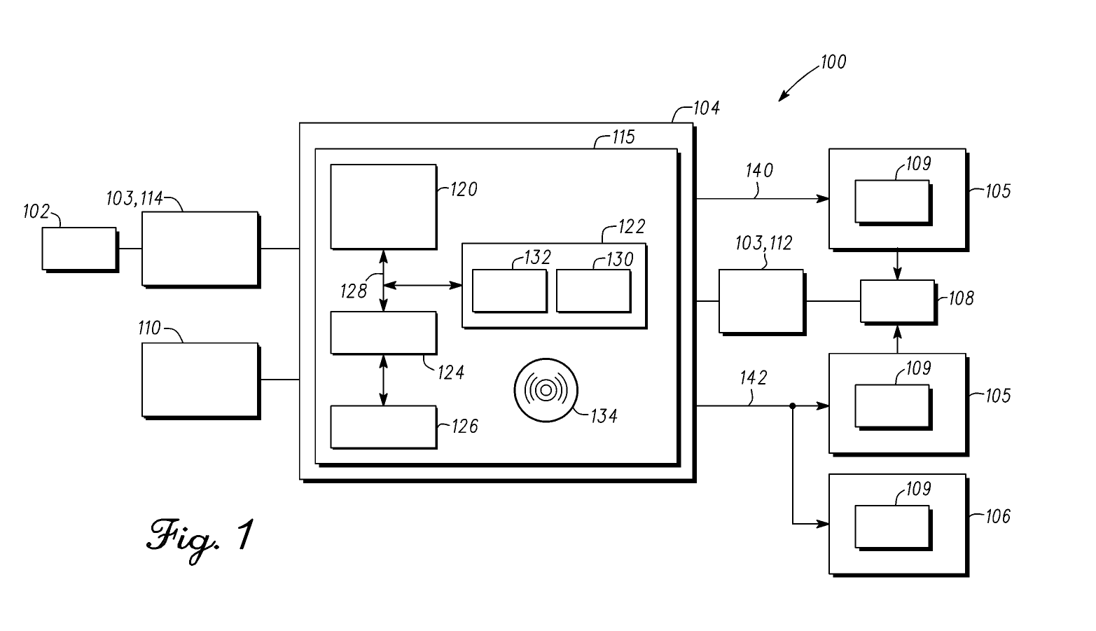

FIG. 1 is a block diagram of an exemplary braking system 100 for use in a brake-by-wire system of a vehicle, such as an automobile. In a preferred embodiment, the vehicle comprises an automobile, such as a sedan, a sport utility vehicle, a van, or a truck. However, the type of vehicle may vary in different embodiments.

As depicted in FIG. 1, the braking system 100 includes a brake pedal 102, one or more sensors 103, a controller 104, one or more friction braking components 105, and one or more regenerative braking components 106. In certain embodiments, the braking system 100 may include and/or be coupled to one or more other modules 110, for example a global positioning system (GPS) device and/or one or more other modules that provide measurements or information to the controller 104, for example regarding one or positions, speeds, and/or other values pertaining to the vehicle and/or components thereof. The braking system 100 is used in connection with a first axle 140 and a second axle 142. Each of the first and second axles 140, 142 has one or more wheels 108 of the vehicle disposed thereon.

The friction braking components 105 and the regenerative braking components each have respective brake units 109. Certain of the brake units 109 are disposed along a first axle 140 of the vehicle along with certain of the wheels 108, and certain other of the brake units 109 are disposed along a second axle 142 of the vehicle along with certain other of the wheels 108. In a preferred embodiment, the first axle 140 is a friction, non-regenerative braking axle coupled to a respective friction braking component 105, and the second axle 142 is a regenerative and friction braking axle coupled to the regenerative braking component 106 and a respective friction braking component 105.

The brake pedal 102 provides an interface between an operator of a vehicle and a braking system or a portion thereof, such as the braking system 100, which is used to slow or stop the vehicle. To initiate the braking system 100, an operator would typically use his or her foot to apply a force to the brake pedal 102 to move the brake pedal 102 in a generally downward direction. In one preferred embodiment the braking system 100 is an electro-hydraulic system. In another preferred embodiment, the braking system 100 is a hydraulic system.

The one or more sensors 103 include one or more wheel speed sensors 112 and one or more brake pedal sensors 114. The wheel speed sensors 112 are coupled to one or more of the wheels 108, and measure one or more speeds thereof. These measurements and/or information thereto are provided to the controller 104 for processing and for control of regenerative braking.

The brake pedal sensors 114 are coupled between the brake pedal 102 and the controller 104. Specifically, in accordance with various preferred embodiments, the brake pedal sensors 114 preferably include one or more brake pedal force sensors and/or one or more brake pedal travel sensors. The number of brake pedal sensors 114 may vary. For example, in certain embodiments, the braking system 100 may include a single brake pedal sensor 114. In various other embodiments, the braking system 100 may include any number of brake pedal sensors 114.

The brake pedal travel sensors, if any, of the brake pedal sensors 114 provide an indication of how far the brake pedal 102 has traveled, which is also known as brake pedal travel, when the operator applies force to the brake pedal 102. In one exemplary embodiment, brake pedal travel can be determined by how far an input rod in a brake master cylinder has moved.

The brake pedal force sensors, if any, of the brake pedal sensors 114 determine how much force the operator of braking system 100 is applying to the brake pedal 102, which is also known as brake pedal force. In one exemplary embodiment, such a brake pedal force sensor, if any, may include a hydraulic pressure emulator and/or a pressure transducer, and the brake pedal force can be determined by measuring hydraulic pressure in a master cylinder of the braking system 100.

Regardless of the particular types of brake pedal sensors 114, the brake pedal sensors 114 detect one or more values (such as brake pedal travel and/or brake pedal force) pertaining to the drivers' engagement of the brake pedal 102. The brake pedal sensors 114 also provide signals or information pertaining to the detected values pertaining to the driver's engagement of the brake pedal 102 to the computer system 115 for processing by the computer system 115.

The controller 104 is coupled between the sensors 103 (and, in some cases, the other modules 110), the friction and regenerative braking components 105, 106 (and the respective brake units 109 thereof), and the first and second axles 140, 142. Specifically, the controller 104 monitors the driver's engagement of the brake pedal 102 and the measurements from the sensors 103 (and, in some cases, information provided by the other modules 110), provides various calculations and determinations pertaining thereto, and controls braking of the vehicle and adjusts braking torque via braking commands sent to the brake units 109 by the controller 104 along the first and second axles 140, 142.

In the depicted embodiment, the controller 104 comprises a computer system 115. In certain embodiments, the controller 104 may also include one or more of the sensors 103, among other possible variations. In addition, it will be appreciated that the controller 104 may otherwise differ from the embodiment depicted in FIG. 1, for example in that the controller 104 may be coupled to or may otherwise utilize one or more remote computer systems and/or other control systems.

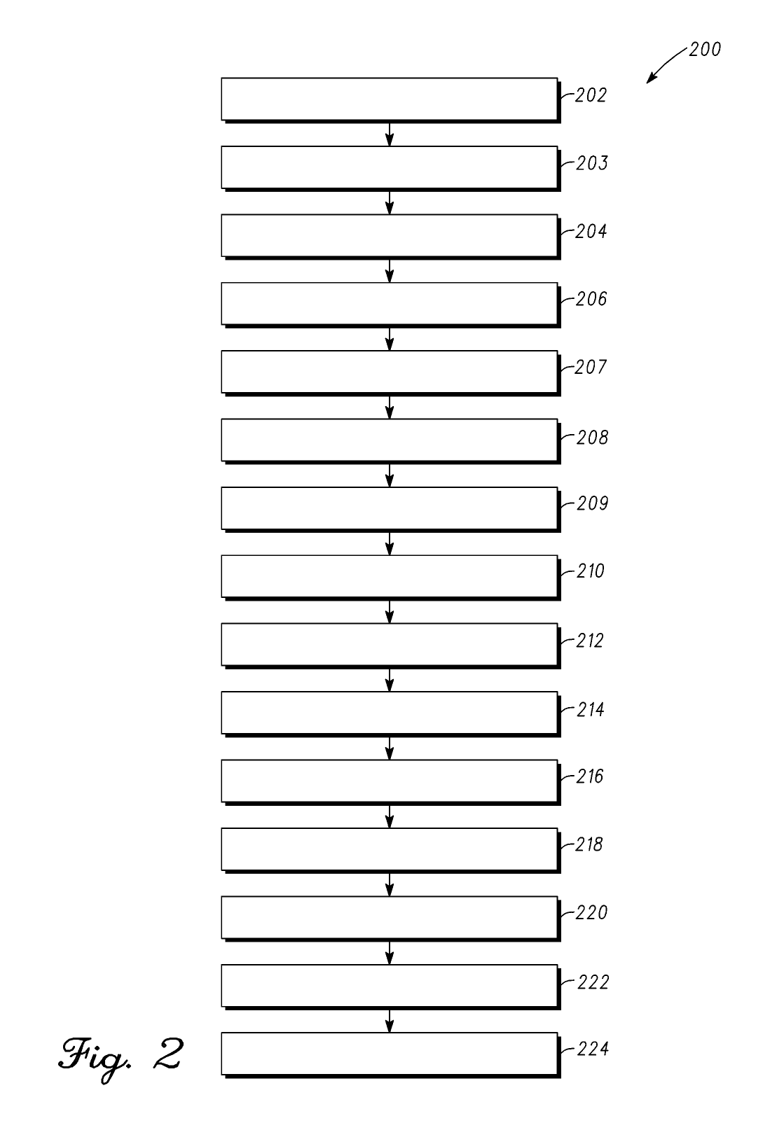

In the depicted embodiment, the computer system 115 is coupled between the brake pedal sensors 114, the brake units 109, and the first and second axles 140, 142. The computer system 115 receives the signals or information from the various sensors 103 and the other modules 110, if any, and further processes these signals or information in order to control braking of the vehicle and apply appropriate amounts of braking torque or pressure to the friction braking component 105 and the regenerative braking component 106 along the first axle 140 and the second axle 142, respectively, via braking commands sent to the brake units 109 by the computer system 115 based at least in part on a wheel slip of the vehicle. In a preferred embodiment, these and other steps are conducted in accordance with the process 200 depicted in FIG. 2 and described further below in connection therewith.

In the depicted embodiment, the computer system 115 includes a processor 120, a memory 122, an interface 124, a storage device 126, and a bus 128. The processor 120 performs the computation and control functions of the computer system 115 and the controller 104, and may comprise any type of processor or multiple processors, single integrated circuits such as a microprocessor, or any suitable number of integrated circuit devices and/or circuit boards working in cooperation to accomplish the functions of a processing unit. During operation, the processor 120 executes one or more programs 130 contained within the memory 122 and, as such, controls the general operation of the controller 104 and the computer system 115, preferably in executing the steps of the processes described herein, such as the process 200 depicted in FIG. 2 and described further below in connection therewith.

The memory 122 can be any type of suitable memory. This would include the various types of dynamic random access memory (DRAM) such as SDRAM, the various types of static RAM (SRAM), and the various types of non-volatile memory (PROM, EPROM, and flash). The bus 128 serves to transmit programs, data, status and other information or signals between the various components of the computer system 115. In a preferred embodiment, the memory 122 stores the above-referenced program 130 along with one or more look-up tables 132 that are used in controlling the braking and adjusting braking torque in accordance with steps of the process 200 depicted in FIG. 2 and described further below in connection therewith. In certain examples, the memory 122 is located on and/or co-located on the same computer chip as the processor 120.

The interface 124 allows communication to the computer system 115, for example from a system driver and/or another computer system, and can be implemented using any suitable method and apparatus. It can include one or more network interfaces to communicate with other systems or components. The interface 124 may also include one or more network interfaces to communicate with technicians, and/or one or more storage interfaces to connect to storage apparatuses, such as the storage device 126.

The storage device 126 can be any suitable type of storage apparatus, including direct access storage devices such as hard disk drives, flash systems, floppy disk drives and optical disk drives. In one exemplary embodiment, the storage device 126 comprises a program product from which memory 122 can receive a program 130 that executes one or more embodiments of one or more processes of the present disclosure, such as the process 200 of FIG. 2 or portions thereof. In another exemplary embodiment, the program product may be directly stored in and/or otherwise accessed by the memory 122 and/or a disk (e.g. disk 134), such as that referenced below.

The bus 128 can be any suitable physical or logical means of connecting computer systems and components. This includes, but is not limited to, direct hard-wired connections, fiber optics, infrared and wireless bus technologies. During operation, the program 130 is stored in the memory 122 and executed by the processor 120.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 120) to perform and execute the program. Such a program product may take a variety of forms, and that the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will similarly be appreciated that the computer system 115 may also otherwise differ from the embodiment depicted in FIG. 1, for example in that the computer system 115 may be coupled to or may otherwise utilize one or more remote computer systems and/or other control systems.

The brake units 109 are coupled between the controller 104 and the wheels 108. In the depicted embodiment, the brake units 109 are disposed along the first axle 140 and are coupled to certain wheels 108 on the first axle 140, and other of the brake units 109 are disposed along the second axle 142 and are coupled to other wheels of the second axle 142. The brake units 109 receive the braking commands from the controller 104, and are controlled thereby accordingly.

The brake units 109 can include any number of different types of devices that, upon receipt of braking commands, can apply the proper braking torque as received from the controller 104. For example, in an electro-hydraulic system, the brake units 109 can comprise an actuator that can generate hydraulic pressure that can cause brake calipers to be applied to a brake disk to induce friction to stop a vehicle. Alternatively, in an electro-mechanical brake-by-wire system, the brake units 109 can comprise a wheel torque-generating device that operates as a vehicle brake. The brake units 109 can also be regenerative braking devices, in which case the brake units 109, when applied, at least facilitate conversion of kinetic energy into electrical energy.

FIG. 2 is a flowchart of a process 200 for adjusting regenerative braking torque and controlling braking, in accordance with an exemplary embodiment. The process 200 can be implemented in connection with the braking system 100 of FIG. 1, the controller 104, and/or the computer system 115 of FIG. 1, in accordance with an exemplary embodiment.

As depicted in FIG. 2, the process 200 begins with the step of receiving one or more braking requests (step 202). The braking requests preferably pertain to values pertaining to engagement of the brake pedal 102 by a driver of the vehicle. In certain preferred embodiments, the braking requests pertain to values of brake pedal travel and/or brake pedal force as obtained by the brake pedal sensors 114 of FIG. 1 and provided to the computer system 115 of FIG. 1. Also in a preferred embodiment, the braking requests are received and obtained, preferably continually, at different points or periods in time throughout a braking event for the vehicle.

A driver-requested braking torque is calculated (step 203). Specifically, the driver-requested braking torque preferably corresponds to an amount of braking torque consistent with the braking requests of step 202, for example as determined by the force applied to the brake pedal 102 by the operator or the distance that the brake pedal 102 has travelled as a result of the operator's engagement of the brake pedal 102. The driver-requested braking torque is preferably calculated by the processor 120 of FIG. 1.

In addition, one or more front wheel speed values are obtained (step 204). The front wheel speed values are preferably measured by wheel speed sensors 112 of FIG. 1 and provided to the processor 120 of FIG. 1 for processing. Alternatively, the front wheel speed values may be calculated by the processor 120 of FIG. 1 based on information provided thereto by one or more wheel speed sensors 112 of FIG. 1. In one preferred embodiment, an average front wheel speed value is calculated by the processor 120 of FIG. 1 in step 204 using raw front wheel speed values measured by wheel speed sensors 112 of FIG. 1. In another embodiment, a maximum and/or minimum front wheel speed value may be calculated by the processor 120 of FIG. 1 in step 204 using raw front wheel speed values measured by wheel speed sensors 112 of FIG. 1.

One or more rear wheel speed values are also obtained (step 206). The rear wheel speed values are preferably measured by wheel speed sensors 112 of FIG. 1 and provided to the processor 120 of FIG. 1 for processing. Alternatively, the rear wheel speed values may be calculated by the processor 120 of FIG. 1 based on information provided thereto by one or more wheel speed sensors 112 of FIG. 1. In one preferred embodiment, an average rear wheel speed value is calculated by the processor 120 of FIG. 1 in step 206 using raw rear wheel speed values measured by wheel speed sensors 112 of FIG. 1. In another embodiment, a maximum and/or minimum rear wheel speed value may be calculated by the processor 120 of FIG. 1 in step 206 using raw rear wheel speed values measured by wheel speed sensors 112 of FIG. 1.

Also as depicted in FIG. 2, one or more vehicle speed values are also received or calculated (step 207). The vehicle speed values are preferably calculated by the processor 120 of FIG. 1 using the front wheel speed values of step 204 and the rear wheel speed values of step 206. However, this may vary. For example, in certain embodiments, one or more vehicle speed values may be obtained by one or more other modules 110 of FIG. 1, such as a global positioning system (GPS) device.

In addition, a vehicle deceleration is also determined (step 208). In a preferred embodiment, the vehicle deceleration is calculated by the processor 120 of FIG. 1 using various vehicle speed values over time from various iterations of step 207. However, this may vary. For example, in certain embodiments, one or more vehicle acceleration values (such as a longitudinal acceleration value) may be obtained by one or more other modules 110 of FIG. 1, such as an accelerometer. In yet other embodiments, the vehicle deceleration of step 208 may be calculated from the driver-requested braking torque of step 203. For example, the vehicle deceleration of step 208 may be calculated by the processor 120 of FIG. 1 as a measure of an amount or rate of vehicle deceleration that would be consistent with and/or caused by braking torque in an amount equal to the driver-requested braking torque of step 203 under current vehicle operating conditions.

Front wheel slip values are calculated (step 209). The front wheel slip values are preferably calculated using the front wheel speed values of step 204 and the vehicle speed values of step 207. Preferably, during step 209, the processor 120 of FIG. 1 calculates a difference between the front wheel speed values of step 204 and the vehicle speed values of step 207 and divides this difference by the vehicle speed value of step 207. In one preferred embodiment, an average front wheel slip value is calculated by the processor 120 of FIG. 1 in step 209 by individually calculating the front wheel slip of each front wheel and then taking an average of the resulting individual front wheel slip values. Alternatively, an average front wheel slip value may be calculated by the processor 120 of FIG. 1 in step 209 by subtracting an average front wheel speed value from the vehicle speed value and then dividing this difference by the average wheel speed value. In another embodiment, a maximum front wheel slip value is calculated by the processor 120 of FIG. 1 in step 209 by individually subtracting each front wheel speed value from the vehicle speed value, taking a maximum value of the resulting differences, and then dividing this maximum value by the vehicle speed value. Alternatively, a maximum front wheel slip value may be calculated by the processor 120 of FIG. 1 in step 209 by subtracting a maximum front wheel speed from the vehicle speed and then dividing this difference by the vehicle speed. In yet other embodiments, minimum front wheel speed values may be calculated in one or more similar manners.

Rear wheel slip values are also calculated (step 210). The rear wheel slip values are preferably calculated using the rear wheel speed values of step 206 and the vehicle speed values of step 207. Preferably, the processor 120 of FIG. 1 subtracts the rear wheel speed value of step 206 from the vehicle speed value of step 207 and divides this difference by the vehicle speed value of step 207. In one preferred embodiment, an average rear wheel slip value is calculated by the processor 120 of FIG. 1 in step 210 by individually calculating the rear wheel slip of each rear wheel and then taking an average of the resulting individual rear wheel slip values. Alternatively, an average rear wheel slip value may be calculated by the processor 120 of FIG. 1 in step 210 by subtracting an average rear wheel speed value from the vehicle speed value and then dividing this difference by the average wheel speed value. In another embodiment, a maximum rear wheel slip value is calculated by the processor 120 of FIG. 1 in step 210 by individually subtracting each rear wheel speed value from the vehicle speed value, taking a maximum value of the resulting differences, and then dividing this maximum value by the vehicle speed value. Alternatively, a maximum rear wheel slip value may be calculated by the processor 120 of FIG. 1 in step 210 by subtracting a maximum rear wheel speed from the vehicle speed and then dividing this difference by the vehicle speed. In yet other embodiments, minimum rear wheel speed values may be calculated in one or more similar manners.

One or more relative wheel slip values are also calculated (step 212). The relative wheel slip values preferably comprise measures of a comparison between wheel slip of front wheels of the wheels 108 of FIG. 1 along the first axle 140 of FIG. 1 versus wheel slip of rear wheels of the wheels 108 along the second axle 142 of FIG. 1, or, alternatively stated, a measure of the wheel slip of the front wheels along the first axle 140 of FIG. 1 relative to the wheel slip of the rear wheels along the second axle 142 of FIG. 1. The relative wheel slip value represents a comparison between the front wheel slip of step 209 and the rear wheel slip of step 210.

In certain preferred embodiments, during step 212, the relative wheel slip value is calculated by subtracting one or more front wheel slip values of step 209 from one or more respective rear wheel slip values of step 210. In one such embodiment, an average front wheel slip value is subtracted from an average rear wheel slip value to determine a relative slip value in step 212. In another embodiment, a maximum front wheel slip value is subtracted from a maximum rear wheel slip value to determine a relative slip value in step 212. In yet another embodiment, a minimum front wheel slip value is subtracted from a minimum rear wheel slip value to determine a relative slip value in step 212. The relative wheel slip is preferably calculated by the processor 120 of FIG. 1.

A current value of regenerative braking torque is received or calculated (step 214). In one exemplary embodiment, the current value of regenerative braking torque pertains to a current or most recent level of braking torque provided by or braking pressure provided to the regenerative braking component 106 of FIG. 1 via the second axle 142 of FIG. 1. The current value of regenerative braking is preferably calculated and/or received at least in part by the processor 120 of FIG. 1.

A current value of friction braking torque is also received or calculated (step 216). In one exemplary embodiment, the current value of friction braking torque pertains to a current or most recent level of braking torque provided by or braking pressure provided to the friction braking components 105 of FIG. 1 via the first axle 140 and the second axle 142 of FIG. 1. The current value of friction braking is preferably determined and/or received at least in part by the processor 120 of FIG. 1.

An adjustment to the regenerative braking torque is determined (step 218). In a preferred embodiment, during step 218, the adjustment in step 218 comprises a desired magnitude or rate of change in the regenerative braking torque for or braking pressure applied to the brake units 109 of the regenerative braking component 106 of FIG. 1 via the second axle 142 of FIG. 1. The adjustment is determined using the vehicle deceleration of step 208 and the relative wheel slip value(s) of step 212.

Specifically, during step 218, the processor 120 of FIG. 1 preferably utilizes a look-up table 132 stored in the memory 122 of FIG. 1. The look-table includes desired regenerative braking adjustments (as the output, or dependent variable) based on various levels of vehicle deceleration and relative wheel slip (as the inputs, or independent variables).

Preferably, for a particular vehicle deceleration value, a relatively larger absolute value of relative wheel slip will result in a desired decrease in regenerative braking torque if the absolute value of the relative wheel slip is greater than a predetermined relative wheel slip threshold, while a relatively smaller absolute value of relative wheel slip will result in a desired increase in regenerative braking torque if the absolute value of the relative wheel slip is greater than the predetermined relative wheel slip threshold. The predetermined relative wheel slip threshold is dependent upon, and is preferably inversely related to, the vehicle deceleration. For example, for a vehicle deceleration of 0.1 g (in which “g” corresponds to the gravity factor, equal to approximately 9.81 meters per second squared), the wheel slip threshold is preferably in a range between 0% and 2.25% (with the % referring to the wheel slip as a percentage of the vehicle velocity), and is most preferably approximately equal to 2%. By way of further example, for a vehicle deceleration of 0.2 g, the wheel slip threshold is preferably in a range between 0% and 2.125%, and is most preferably approximately equal to 1%. Also in this embodiment, full regenerative braking torque is utilized if the absolute value of the relative wheel slip is less than the predetermined relative wheel slip threshold (as represented in region 404 of FIG. 4, described further below). Conversely, if the absolute value of the relative wheel slip is greater than the predetermined relative wheel slip threshold, then regenerative braking may (i) still be provided but in a less than full amount if the absolute value of the relative wheel slip is less than a second predetermined relative wheel slip threshold (as represented in region 406 of FIG. 4, described further below), or (ii) be no longer provided at all if the absolute value of the relative wheel slip is greater than the second predetermined relative wheel slip threshold (as represented in region 408 of FIG. 4, described further below). The maximum amount of regenerative braking torque may be determined by factors such as the charging capability of the high voltage battery, the desired limits of brake balancing, and the like.

In addition, preferably for a particular relative wheel slip value, a relatively larger vehicle deceleration will result in a desired decrease in regenerative braking torque if the vehicle deceleration value is less than a predetermined vehicle deceleration threshold, while a relatively smaller vehicle deceleration will result in a desired increase in regenerative braking torque if the vehicle deceleration value is greater than the predetermined vehicle deceleration threshold. The predetermined vehicle deceleration threshold is dependent upon, and is preferably inversely related to, the relative wheel slip. By way of example, for a relative wheel slip of 2.25%, the predetermined vehicle deceleration threshold is preferably in a range between 0 g and 0.1 g, and is most preferably approximately equal to 0.1 g. By way of further example, for a relative wheel slip of 2.125%, the predetermined vehicle deceleration threshold is preferably in a range between 0.1 g and 0.2 g, and is most preferably approximately equal to 0.2 g. Also in this embodiment, full regenerative braking torque (which may be determined as described in the immediately preceding paragraph) is utilized if the vehicle deceleration is less than the predetermined vehicle deceleration threshold (as represented in region 404 of FIG. 4, described further below). Conversely, if the vehicle deceleration is greater than the predetermined vehicle deceleration threshold, then regenerative braking may (i) still be provided but in a less than full amount if the vehicle deceleration is less than a second predetermined vehicle deceleration threshold (as represented in region 406 of FIG. 4, described further below), or (ii) be no longer provided at all if the vehicle deceleration is greater than the second predetermined vehicle deceleration threshold (as represented in region 408 of FIG. 4, described further below).

In addition, in certain embodiments, a desired adjustment of friction braking torque is also determined (step 220). In a preferred embodiment, during step 220, the desired adjustment of the friction braking torque (and/or the duration thereof) are determined by the processor 120 of FIG. 1 with respect to braking torque for or braking pressure applied to the brake units 109 of the friction braking components 105 of FIG. 1 via the first axle 140 and the second axle 142 of FIG. 1. In one preferred embodiment, the desired adjustment of the friction braking torque of step 220 is inversely related to the desired magnitude or rate of change of the regenerative braking torque of step 218, for example via a one to one ratio via another look-up table 132 stored in the memory 122 of FIG. 1 or a linear function relating the desired magnitude or rate of change of friction braking torque to the desired magnitude or rate of change of regenerative braking torque. However, this may vary in other embodiments.

Next, the regenerative braking torque is modulated (step 222). In a preferred embodiment, the regenerative braking torque is modulated by adjusting, via instructions from the processor 120 of FIG. 1, the braking torque for or braking pressure applied to the brake units 109 of the regenerative braking component 106 of FIG. 1 via the second axle 142 of FIG. 1 in order to implement the desired adjustment to the regenerative braking torque of step 218. The modulation (or adjustment) of the regenerative braking torque of step 222 provides for a more neutral-balanced braking with respect to the first and second axles 140, 142 of FIG. 1 during an event in which the vehicle may be approaching instability. As a result, vehicle stability is enhanced, and additional regenerative braking is conducted (with additional corresponding regenerative energy capture) as compared with existing techniques and systems, for example that may automatically disable regenerative braking torque if the vehicle may be deemed to be approaching instability.

In addition, in certain embodiments, the friction braking torque is also modulated (step 224). In a preferred embodiment, the friction braking torque (and thereby, the friction braking pressure) is modulated by adjusting, via instructions from the processor 120 of FIG. 1, the braking torque for or braking pressure applied to the brake units 109 of the friction braking component 105 of FIG. 1 via the first axle 140 of FIG. 1 in order to implement the desired adjustment of the friction braking torque of step 220. Preferably, when the regenerative braking torque is reduced in step 222, the friction braking torque is increased on both the front and rear axles 140, 142 of FIG. 1 at the same rate, with the sum of the increases in friction braking torque of the front and rear axles 140, 142 being equal to the decrease in the regenerative braking torque of the rear axle 142. This effectively re-allocates or moves braking torque from the rear axle 142 to the front axle 140 of FIG. 1, to thereby provide a more neutral balance for the braking of the vehicle between the front and rear axles 140, 142 of FIG. 1 in which the total braking pressure and torque on the front axle 140 is made more closely equal to the total braking pressure and torque on the rear axle 142.

In a preferred embodiment, the process 200 then returns to step 202, described above. Steps 202-224 (or an applicable subset thereof, as may be appropriate in certain embodiments) preferably repeat so long as the vehicle is being operated.

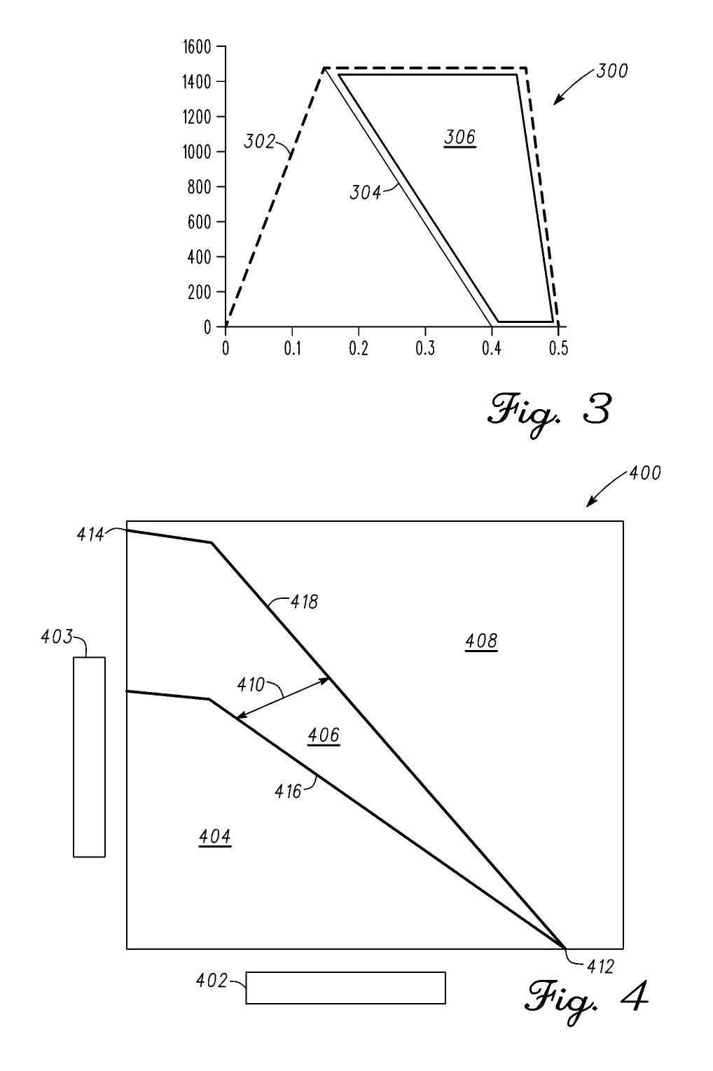

FIG. 3 is a graphical representation 300 illustrating additional regenerative braking that may be attained using the braking system 100 of FIG. 1 and the process 200 of FIG. 2, in accordance with an exemplary embodiment. On FIG. 3, the horizontal axis represents vehicle deceleration (in units of the gravity factor, “g”), and the vertical axis represents driver requested braking torque (in Nm). The graphical representation 300 depicts an exemplary driver-requested braking torque 302 and an exemplary regenerative braking request 304 that would be required in order to maintain a current or existing level of brake biasing between the front and rear axles 140, 142 of FIG. 1. However, by using the braking system 100 and the process 200 of FIG. 2, regenerative braking can be increased so as to capture additional regenerative braking as denoted by region 306 of the graphical representation 300. This additional regenerative braking can be attained via the braking system 100 of FIG. 1 and the process 200 of FIG. 2 in part because regenerative braking is modulated, rather than disabled, at higher vehicle decelerations, and in part because this provides flexibility to use a larger maximum regenerative braking amount when vehicle stability is not an issue.

FIG. 4 is a graphical representation 400 illustrating relative amounts of regenerative braking that may be provided using the braking system 100 of FIG. 1 and the process 200 of FIG. 1, in accordance with an exemplary embodiment. The graphical representation 400 uses vehicle deceleration 402 (in units of the gravity factor, “g”) for the horizontal axis, and relative wheel slip between the front and rear wheels (in percentage terms) for the vertical access. In a first region 404 with relatively low vehicle deceleration 402 and relative wheel slip 403, full regenerative braking is utilized. Within the first region 404, the regenerative braking torque is preferably equal to the driver intended braking torque.

In a second region 406 with intermediate values of vehicle deceleration 402 and/or relative wheel slip 403 (preferably, that are larger than the respective values of the first region 404 described above but smaller than the respective values of the third region 408 described below), regenerative braking torque is reduced below the full regenerative braking amount. Within the second region 406, the regenerative braking torque is preferably less than the driver intended braking torque but greater than zero. Within the second region 406, the amount of regenerative braking torque may follow a transition 410 between full regenerative braking and zero regenerative braking.

In a third region 408 with relatively higher vehicle deceleration 402 and/or relative wheel slip 403 (as compared with both the first region 404 and the second region 406), regenerative braking torque is reduced below that of the second region 406. In a preferred embodiment, regenerative braking torque is reduced to zero in the third region 408. In the depicted embodiment, no regenerative braking torque is provided (i.e., falling within the third region 408) if the vehicle deceleration 402 is greater than a first threshold 412, the relative wheel slip 403 is greater than a second threshold 414, or some combination or function of the vehicle deceleration 402 and the relative wheel slip 403 is greater than another threshold, such as may be determined using the first and/or second functions 416, 418, described below. In one exemplary embodiment, the first threshold 412 is equal to approximately 0.5 g, and the second threshold 414 is equal to approximately 5.5%. However, this may vary in other embodiments.

A relative amount of regenerative braking torque can be expressed in terms of a first function 416 and a second function 418 depicted in FIG. 4. The first and section functions 416, 418 both relate vehicle deceleration 402 (as an independent variable) to relative wheel slip 403 (as a dependent variable). If the actual (or measured) relative wheel slip 403 is less than the value of the relative wheel slip 403 that would be generated as an output by the first function 416 using the actual (or measured) vehicle deceleration 402 as an input, then full regenerative braking is provided (i.e., falling within the first region 404). If the actual (or measured) relative wheel slip 403 is greater than (a) the value of the relative wheel slip 403 that would be generated as an output by the first function 416 using the actual (or measured) vehicle deceleration 402 as an input, but is less than (b) the value of the relative wheel slip 403 that would be generated as an output by the second function 418 using the actual (or measured) vehicle deceleration 402 as an input, then an intermediate amount of regenerative braking is provided (i.e., falling within the second region 406). If the actual (or measured) relative wheel slip 403 is greater than the value of the relative wheel slip 403 that would be generated as an output by the second function 418 using the actual (or measured) vehicle deceleration 402 as an input, then no regenerative braking is provided (i.e., falling within the third region 408). In one exemplary embodiment, the first function 416 has an x-intercept of approximately 0.5 g and a y-intercept of approximately 2.5%, and the second function 418 has an x-intercept of approximately 0.5 g and a y-intercept of approximately 5.5%.

Accordingly, improved methods, program products, and systems are provided for controlling braking and adjusting regenerative braking torque for braking systems of vehicles, such as automobiles. The improved methods, program products, and systems provide for adjustment of regenerative braking torque based on a vehicle deceleration and a relative wheel slip between the front and rear wheels. As a result, additional regenerative braking may be attained in a greater amount as compared with traditional techniques, and with potentially enhanced vehicle stability.

It will be appreciated that the disclosed methods and systems may vary from those depicted in the Figures and described herein. For example, as mentioned above, the controller 104 of FIG. 1 may be disposed in whole or in part in any one or more of a number of different vehicle units, devices, and/or systems. In addition, it will be appreciated that certain steps of the process 200 may vary from those depicted in FIG. 2 and/or described above in connection therewith. It will similarly be appreciated that certain steps of the process 200 may occur simultaneously or in a different order than that depicted in FIG. 2 and/or described above in connection therewith. It will also be appreciated that results of the exemplary graphical representation 300 may differ from those depicted in FIG. 3 and/or described above in connection therewith. It will similarly be appreciated that the disclosed methods and systems may be implemented and/or utilized in connection with any number of different types of automobiles, sedans, sport utility vehicles, trucks, and/or any of a number of other different types of vehicles, and in controlling any one or more of a number of different types of vehicle infotainment systems.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

We claim:

1. A method for adjusting regenerative braking torque in a vehicle having wheels and a regenerative braking system providing the regenerative braking torque, the method comprising the steps of:
determining a deceleration of the vehicle;
determining a wheel slip of the wheels; and
adjusting the regenerative braking torque for the regenerative braking system, via a processor, using the deceleration and the wheel slip.

2. The method of claim 1, wherein:
the wheels comprise front wheels and rear wheels;
the step of determining the wheel slip comprises the step of determining a relative wheel slip between the front wheels and the rear wheels; and
the step of adjusting the regenerative braking torque comprises the step of adjusting the regenerative braking torque using the deceleration and the relative wheel slip.

3. The method of claim 2, wherein the step of adjusting the regenerative braking torque comprises the step of determining an adjustment for the regenerative braking torque using the deceleration, the relative wheel slip, and a look-up table relating the deceleration, the relative wheel slip, and the adjustment.

4. The method of claim 2, wherein the step of adjusting the regenerative braking torque comprises the step of reducing the regenerative braking torque from a first non-zero amount to a second non-zero amount as the relative wheel slip increases for a given value of the deceleration, provided that the relative wheel slip is greater than a predetermined threshold.

5. The method of claim 2, wherein the step of adjusting the regenerative braking torque comprises the step of reducing the regenerative braking torque from a first non-zero amount to a second non-zero amount as the deceleration increases for a given value of the relative wheel slip, provided that the deceleration is greater than a predetermined threshold.

6. The method of claim 2, wherein the step of determining the relative wheel slip comprises the steps of:
measuring front wheel speeds of the front wheels;
measuring rear wheel speeds of the rear wheels;
calculating a vehicle speed using the front wheel speeds and the rear wheel speeds;
calculating a front wheel slip of the front wheels using the front wheel speeds and the vehicle speed;
calculating a rear wheel slip of the rear wheels using the rear wheel speeds and the vehicle speed; and
calculating the relative wheel slip using the front wheel slip and the rear wheel slip.

7. The method of claim 6, wherein:
the step of calculating the front wheel slip comprises the step of calculating an average front wheel slip using the front wheel speeds and the vehicle speed;
the step of calculating the rear wheel slip comprises the step of calculating an average rear wheel slip using the rear wheel speeds and the vehicle speed; and
the step of calculating the relative wheel slip comprises the step of calculating an average relative wheel slip using the average front wheel slip and the average rear wheel slip.

8. A program product for adjusting regenerative braking torque in a vehicle having wheels and a regenerative braking system providing the regenerative braking torque, the program product comprising:
a program configured to:
determine a deceleration of the vehicle;
determine a wheel slip of the wheels; and
adjust the regenerative braking torque for the regenerative braking system using the deceleration and the wheel slip; and
a non-transitory computer readable medium bearing the program and containing computer instructions stored therein for causing a computer processor to execute the program.

9. The program product of claim 8, wherein the wheels comprise front wheels and rear wheels, and the program is further configured to:
determine a relative wheel slip between the front wheels and the rear wheels; and
adjust the regenerative braking torque using the deceleration and the relative wheel slip.

10. The program product of claim 9, wherein the program is further configured to determine an adjustment for the regenerative braking torque using the deceleration, the relative wheel slip, and a look-up table relating the deceleration, the relative wheel slip, and the adjustment.

11. The program product of claim 9, wherein the program is further configured to reduce the regenerative braking torque from a first non-zero amount to a second non-zero amount as the relative wheel slip increases for a given value of the deceleration, provided that the relative wheel slip is greater than a predetermined threshold.

12. The program product of claim 9, wherein the program is further configured to reduce the regenerative braking torque from a first non-zero amount to a second non-zero amount as the deceleration increases for a given value of the relative wheel slip, provided that the deceleration is greater than a predetermined threshold.

13. The program product of claim 9, wherein the program is further configured to:
measure front wheel speeds of the front wheels;
measure rear wheel speeds of the rear wheels;
calculate a vehicle speed using the front wheel speeds and the rear wheel speeds;
calculate a front wheel slip of the front wheels using the front wheel speeds and the vehicle speed;
calculate a rear wheel slip of the rear wheels using the rear wheel speeds and the vehicle speed; and
calculate the relative wheel slip using the front wheel slip and the rear wheel slip.

14. The program product of claim 13, wherein the program is further configured to:
calculate an average front wheel slip using the front wheel speeds and the vehicle speed;
calculate an average rear wheel slip using the rear wheel speeds and the vehicle speed; and
calculate an average relative wheel slip using the average front wheel slip and the average rear wheel slip.

15. A system for adjusting regenerative braking torque in a vehicle having wheels and a regenerative braking system providing the regenerative braking torque, the system comprising:
one or more sensors configured to measure a wheel speed of the wheels; and
a processor coupled to the one or more sensors and configured to:
determine a deceleration of the vehicle;
determine a wheel slip using the wheel speed; and
adjust the regenerative braking torque for the regenerative braking system using the deceleration and the wheel slip.

16. The system of claim 15, wherein:
the wheels comprise front wheels and rear wheels; and
the processor is further configured to:
determine a relative wheel slip between the front wheels and the rear wheels; and
adjust the regenerative braking torque using the deceleration and the relative wheel slip.

17. The system of claim 16, further comprising:
a memory configured to store a look-up table relating the deceleration, the relative wheel slip, and a desired adjustment for the regenerative braking torque, wherein the processor is further configured to determine an adjustment for the regenerative braking torque using the deceleration, the relative wheel slip, and the look-up table.

18. The system of claim 16, wherein:
the one or more sensors comprise:
one or more front wheel speed sensors configured to measure front wheel speeds of the front wheels;
one or more rear wheel speed sensors configured to measure rear wheel speeds of the rear wheels; and
the processor is further configured to:
calculate a vehicle speed using the front wheel speeds and the rear wheel speeds;
calculate a front wheel slip of the front wheels using the front wheel speeds and the vehicle speed;
calculate a rear wheel slip of the rear wheels using the rear wheel speeds and the vehicle speed; and
calculate the relative wheel slip using the front wheel slip and the rear wheel slip.

19. The system of claim 18, wherein the processor is further configured to calculate the deceleration using the vehicle speed.

20. The system of claim 18, wherein the processor is further configured to:
calculate an average front wheel slip using the front wheel speeds and the vehicle speed;
calculate an average rear wheel slip using the rear wheel speeds and the vehicle speed; and
calculate an average relative wheel slip using the average front wheel slip and the average rear wheel slip.
